(19) United States
(12) Patent Application Publication
(10) Pub. No.: US 2013/0103491 A1
(43) Pub. Date: Apr. 25, 2013

(54) Computer-Implemented Systems and Methods for Facilitating the Distribution of Advertisements

(71) Applicant: Alfred Silverstein, Norwalk, CT (US)

(72) Inventor: Alfred Silverstein, Norwalk, CT (US)

(21) Appl. No.: 13/588,037

(22) Filed: Aug. 17, 2012

Related U.S. Application Data
(60) Provisional application No. 61/526,487, filed on Aug. 23, 2011.

(51) Int. Cl. G06Q 30/02

(52) U.S. Cl. CPC G06Q 30/0273
USPC 705/14.45; 705/14.7; 705/14.41

(57) ABSTRACT

Systems and methods for publishers to barter advertisement space inventory and advertisements with other publishers by transmitting an advertisement from a first publisher for display on available advertisement space inventory of a second publisher, where the advertisement is transmitted to the second publisher in exchange for credits of the first publisher previously earned for displaying other advertisements for other publishers. An advertisement and a bid amount are received from a first publisher, and an identification of an available advertisement space inventory is received from a second publisher. The advertisement is matched with the available inventory. A credit amount for the first publisher is deducted based on monitored performance of the advertisement displayed by the second publisher, and a credit amount for the second publisher is added based on the monitored performance of the advertisement displayed by the second publisher.

### CROSS REFERENCE TO RELATED APPLICATIONS

This application claims priority to U.S. Provisional Patent Application No. 61/526,487, filed Aug. 23, 2011, entitled “Computer-Implemented Systems and Methods for Facilitating the Distribution of Advertising,” the entirety of which is herein incorporated by reference.

### TECHNICAL FIELD

This document relates generally to Internet marketing and more particularly to online advertisement placement.

### BACKGROUND

Internet marketing involves the promotion of products or services online over the Internet. For example, advertisements may be included in a webpage, electronic message (e.g., e-mail), Internet game, or other medium to bring attention to a topic that an advertiser wishes to promote. Consumers are often encouraged to interact with displayed advertisements (e.g., via a mouse click) to gain access to more information about the product or service being advertised.

Popular online mediums (e.g., news websites, online magazines, massively multiplayer online role-playing games) may be displayed to millions of consumers daily, offering very high volumes of available advertisement space. This advertisement space is usually purchased for money, such as on a cost-per-impression or cost per click through basis.

### SUMMARY

In accordance with the teachings provided herein, systems and methods are provided for publishers to barter advertisement space inventory and advertisements with other publishers by transmitting an advertisement from a first publisher for display on available advertisement space inventory of a second publisher, where the advertisement is transmitted to the second publisher in exchange for credit previously earned by the first publisher for displaying other advertisements for other publishers. In one example, one or more data processors perform the steps of a computer-implemented method. In the method, an advertisement is received from a first publisher, and an identification of an available advertisement space inventory is received from a second publisher. The advertisement is matched with the available inventory and the advertisement is transmitted to the second publisher for display. Performance of the advertisement displayed by the second publisher is monitored. A credit amount for the first publisher is deducted based on the monitored performance of the advertisement displayed by the second publisher, where credit was previously earned by the first publisher for displaying other advertisements for other publishers, and a credit amount for the second publisher is added based on the monitored performance of the advertisement displayed by the second publisher.

In another example, one or more computer-readable storage mediums are encoded with instructions for commanding one or more data processors to perform a method for publishers to barter advertisement space inventory and advertisements with other publishers by transmitting an advertisement from a first publisher for display on available advertisement space inventory of a second publisher, where the advertisement is transmitted to the second publisher in exchange for credit previously earned by the first publisher for displaying other advertisements for other publishers. In the method, an advertisement is received from a first publisher, and an identification of an available advertisement space inventory is received from a second publisher. The advertisement is matched with the available inventory and the advertisement is transmitted to the second publisher for display. Performance of the advertisement displayed by the second publisher is monitored. A credit amount for the first publisher is deducted based on the monitored performance of the advertisement displayed by the second publisher, where credit was previously earned by the first publisher for displaying other advertisements for other publishers, and a credit amount for the second publisher is added based on the monitored performance of the advertisement displayed by the second publisher.

As a further example, a computer-implemented system for publishers to barter advertisement space inventory and advertisements with other publishers by transmitting an advertisement from a first publisher for display on available advertisement space inventory of a second publisher, where the advertisement is transmitted to the second publisher in exchange for credit previously earned by the first publisher for displaying other advertisements for other publishers may include a server including one or more data processors and one or more computer-readable mediums encoded with instructions for commanding the one or more data processors to execute a publisher advertisement barter module application. The system may also include one or more computer-readable mediums responsive to the publisher advertisement barter module, wherein the one or more computer-readable mediums contain a campaign data store that includes content data associated with advertisements of a plurality of publishers and an accounting data store that includes credit amounts associated with the plurality of publishers. The publisher advertisement barter module assigns the advertisement from the first publisher to the available inventory of the second publisher and transmits the advertisement to the second publisher for display, a credit amount for the first publisher is deducted in response to the display of the advertisement by the second publisher, where credit was previously earned by the first publisher for displaying other advertisements for other publishers, and a credit amount for the second publisher is added in response to the display of the advertisement by the first publisher.

### BRIEF DESCRIPTION OF THE FIGURES

FIG. 1 is a block diagram depicting a computer-implemented publisher ad barter module.

FIG. 2 is a block diagram depicting example subsystems that may be included in a publisher ad barter module.

FIG. 3 is a block diagram depicting example data that may be monitored and maintained by a publisher ad barter module.

FIG. 4 is a block diagram depicting assignment of an advertisement to an available advertisement space.

FIGS. 5-24 depict examples of graphical user interfaces for administration of and monitoring of performance of advertisement campaigns and available advertisement space.

FIGS. 26A, 26B, and 26C depict example systems for use in implementing a publisher ad barter module.

### DETAILED DESCRIPTION

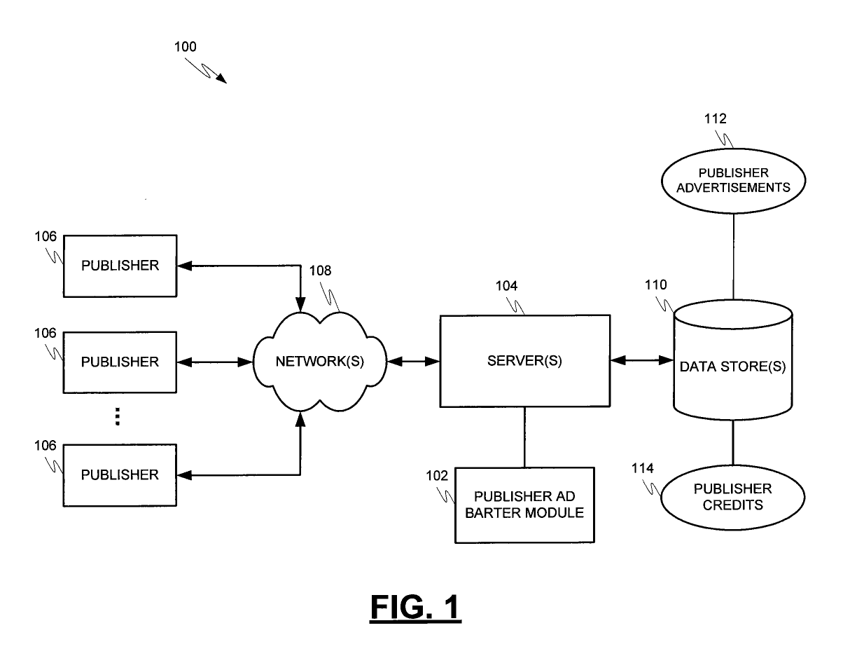

FIG. 1 depicts a computer-implemented publisher ad barter management system for managing the trading of advertisement space inventory (“inventory”) and advertisement (“content”) displays among a community of participating publishers. The publisher ad barter module 102 provides a platform for providing content from a first publisher for display on available inventory of a second publisher. The content is transmitted to the second publisher in exchange for credit that may be previously earned by the first publisher for displaying other advertisements for other publishers.

For example, a publisher ad barter module 102 may provide a platform for publishers (e.g., websites, e-mail providers, terrestrial or satellite radio providers, online gaming platform providers) to barter or trade unsold inventory. A publisher may have a certain inventory of advertisement space. Some of that inventory may be directly sold to an advertiser for a negotiated cost. Some of that inventory may not be directly sold. Other publishers may promote themselves or their products or services using that inventory of available advertisement space using the platform. A publisher bids on other publishers' inventory (e.g., on a cost-per-click (CPC) basis or a cost-per-impression basis (CPM)). The publisher may also provide a budget denoting a maximum that that publisher is willing to spend on using other publishers' inventory over a given period (e.g., an hour, a day, a week, a month, a year). The publisher uses money or credits to pay for use of the other publishers' available inventory. When a publisher's content is displayed on another publisher's available inventory, credits are deducted from an account associated with the publisher whose advertisement is being displayed.

Credits may be earned by a publisher by contributing their own available advertisement space inventory to the system. Credits may be awarded based on a number of other publishers' content displayed or based on a click through rate for the other publishers' displayed content. For example, a publisher offering inventory may be awarded credits based on a click through-rate (CTR) for displayed content times a cost-per-click bid price of the publisher providing the content.

A publisher ad barter module 102 provides systems and methods for publishers to barter advertisement space inventory and advertisement content with other publishers. The publisher ad barter module 102 may be provided using one or more servers 104. One or more publishers 106 interact with the publisher ad barter module 102 via one or more networks 108. The publisher ad barter module 102 may be responsive to one or more data stores 110. The one or more data stores 110 may contain a variety of data associated with the publisher ad barter module 102, such as publisher advertisement content 112 and acquired publisher credits 114.

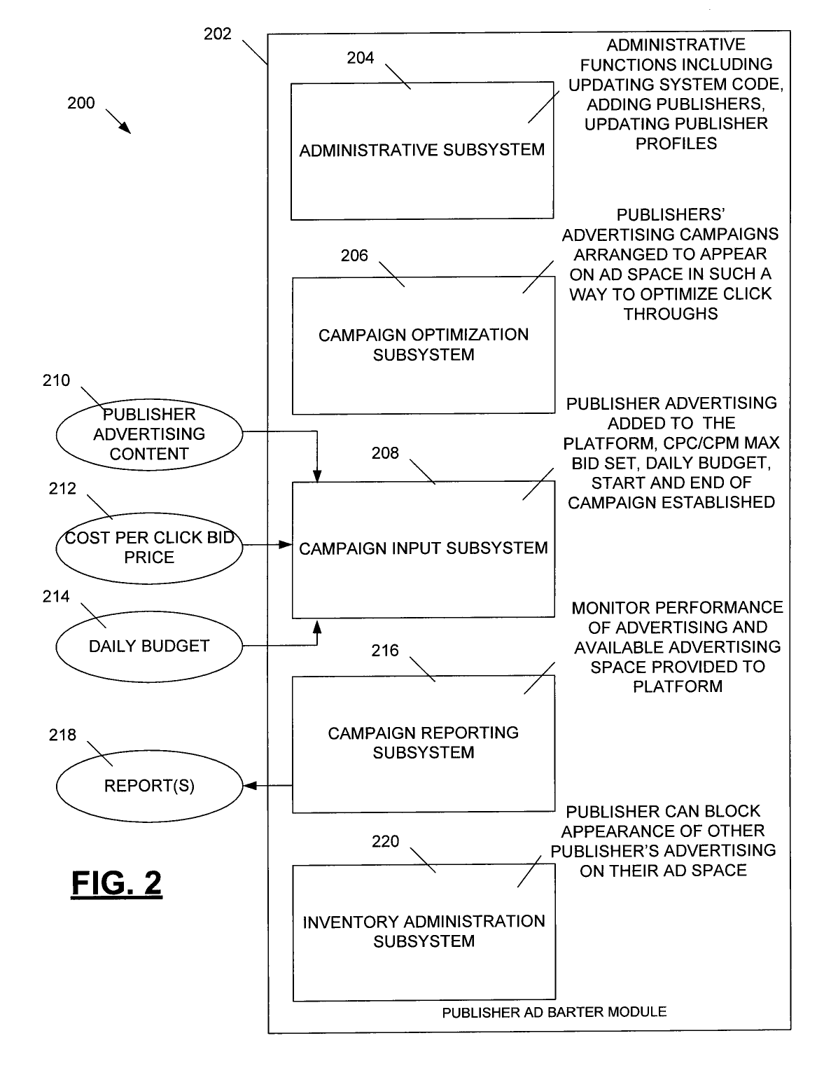

FIG. 2 is a block diagram depicting example subsystems that may be included in a publisher ad barter module. A publisher ad barter module 202 may include an administrative subsystem 204. The administrative subsystem 204 may provide interfaces for and store data associated with administrative functions of the publisher ad barter module 202. For example, the administrative subsystem 204 may manage the adding and updating of computer code for the publisher ad barter module 202. The administrative subsystem 204 may also enable certain publisher account tracking functions. For example, the administrative subsystem 204 may handle the adding of new publishers to the subsystem, updating publisher profiles, and other administrative tasks.

A campaign optimization subsystem 206 may review a publisher's available advertisement space inventory and edit or suggest edits to the available inventory to improve performance. Because publishers' accounts may be credited based on the success of displayed content (e.g., based on a click through rate for displayed content), publishers may be open to suggestions for how to help displayed content be more successful.

A campaign input subsystem 208 receives content from publishers as well as certain parameters for how a publisher's advertising campaign is to be managed. For example, a publisher may provide advertising content 210 in the form of graphics, audio, or text to be displayed on other publishers' available advertisement inventory. A publisher may also provide advertising campaign parameters such as a cost per click bid price 212 (e.g., on an individual publisher basis, on an overall basis), a daily budget 214 for campaign expenses, starting and ending dates for a campaign, as well as other parameters.

A campaign reporting system 216 provides displays where publishers can view the performance of their content as well as the value of their available inventory provided to the platform. One or more reports 218 may be provided to a publisher based on monitored performance. For example, a click through rate can be examined for a particular piece of advertising content. If the click through rate is lower than desired, then the content can be changed to increase response. As another example, a click through rate associated with a particular piece of available inventory may be reviewed. If that click through rate is lower than desired, then the available inventory may be changed (e.g., moved closer to the top of a web page, made larger) to increase response to content displayed on that available inventory.

An inventory administration subsystem 220 provides interfaces for a publisher to manage certain parameters of available inventory provided to the platform. For example, a publisher may block the appearance of a particular other publisher's advertisements or individual advertisements from their web space. Such blocking may be desirable for a number of reasons, including the appropriateness of the other publisher's content on the mediums containing the available inventory.

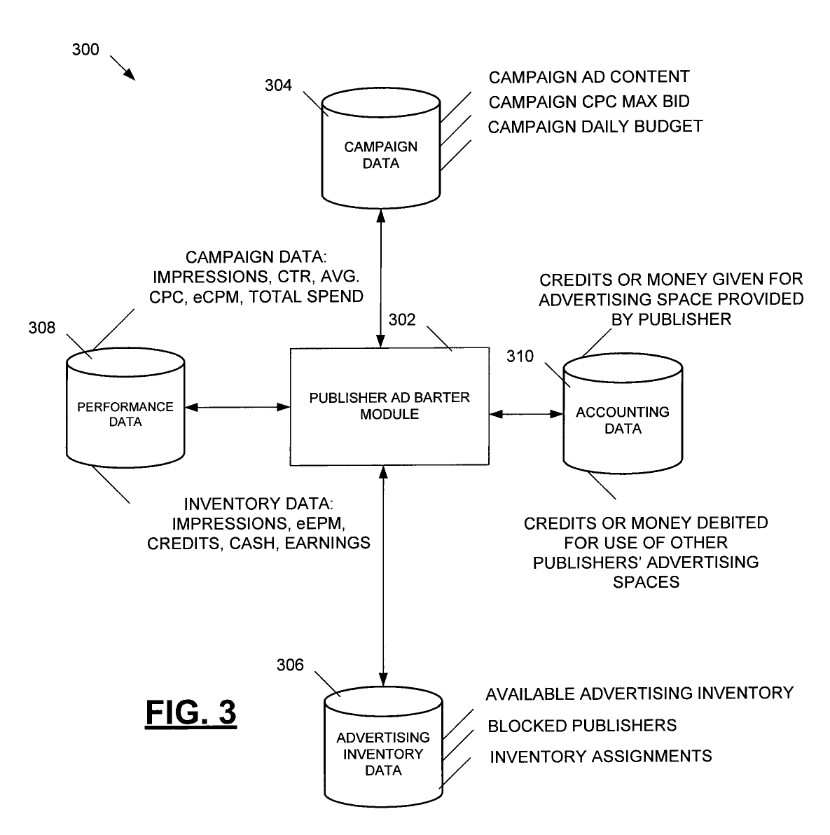

FIG. 3 is a block diagram depicting example data that may be monitored and maintained by a publisher ad barter module. A publisher ad barter module 302 may track several different pieces of data to administer an advertisement barter system. Such data may be stored on one or more computer-readable storage mediums. For example, the publisher ad barter module tracks a variety of campaign data 304 related to particular advertising campaigns. As an illustration, campaign data may include advertisement content, such as graphics, audio, and text to be provided for display in other publishers' available inventory.

The campaign data may also include other parameters associated with an advertising campaign. For example, the campaign data 304 may include bid data identifying how much an advertiser is willing to pay for one content impression, a set of content impressions, or one or more click throughs of provided content. The campaign data 304 may also include budget data that identifies minimums and maximums for how much an advertiser is willing to spend for a particular advertising campaign over a particular time period.

The publisher ad barter module may also manage advertisement inventory data 306. A publisher may provide available inventory to the platform. Content, such as advertisements described in the campaign data 304, are assigned to available inventory, and an account of the available advertisement space provider is credited based on performance of the assigned advertisement. Inventory data 306 may include data identifying available advertisement space of a publisher. For example, tags linked to the platform may be embedded in a web page. When the web page is accessed, the tags send a message to the platform identifying a portion of the web page is available inventory for displaying content. The platform then provides content for display in the available inventory, and accounts may be credited and deducted from appropriately.

The advertisement inventory data 306 may also include identifications of certain publishers whose ads are not permitted to be shown on particular publishers' available inventory. For example, a first publisher may block a second publisher's content from being displayed based on incompatibility or inappropriateness of the second publisher's advertisement content on the first publisher's available inventory. The advertisement inventory data 306 may also track assignments of campaign content to available inventory (e.g., a webpage with available inventory was provided Advertisement #1 to display at 12:01 A.M., Jan. 1, 2011).

The publisher ad barter module 302 may also track performance data 308 for advertising content and available inventory. For example, the publisher ad barter module 302 may track a number of performance metrics related to a particular piece of advertisement content. Those metrics can include a number of total impressions of the content, a click through rate for the content t, an average cost per click metric (an advertisement may be displayed on one publisher's inventory for a first cost per click rate and another publisher's inventory for a second cost per click rate), an effective earnings per thousand impressions metric, an effective cost per acquisition (CPA) metric, and a total spend metric. The publisher ad barter module may also track a number of performance metrics related to a particular inventory. For example, the publisher ad barter module 302 may track a total number of impressions provided for an available inventory, an effective earnings per thousand impressions metric, effective cost per acquisition (CPA) metric, a number of credits earned metric, an amount of cash earned metric, and a total earnings metric for a particular available inventory.

The publisher ad barter module 302 may use the performance data in a variety of ways. For example, the performance data may be used for adding and deducting credits from publishers' accounts based on performance of content and available inventory. Performance data may also be used to attempt to optimally assign content to available inventory. In some scenarios, credits are gained and deducted only upon click throughs by consumers. Thus, the credit economy is made more liquid and lucrative when click throughs for content is maximized (e.g., inventory providers receive more credits for use in displaying their content, advertisers have more consumers clicking on their content, and publisher ad barter module administrators receive more revenue from purchased credits, content cost commissions, and other sources).

To help encourage high click through rates, a publisher ad barter module 302 may attempt to assign content to available inventory based on a likelihood of a click through being enticed by placement of a particular content in a particular inventory. For example, the publisher ad barter module 302 may calculate one or more likelihood of success metrics for different content when an available inventory needs to be filled. The likelihood of success metric may be calculated based on a number of factors including past success of the particular content on the particular available inventory, past success of the particular content on other available inventory of the particular inventory provider, past success of similar content (e.g., content promoting similar products or services) on the particular available inventory, overall popularity of the particular content, high bid values for the particular content, as well as other parameters.

The publisher ad barter module 302 also tracks accounting data 310 for advertisement campaign content and available inventory. For example, the accounting data 310 may include a number of credits or amount of money credited to a particular publisher account for use of the particular publisher's available inventory for displaying content associated with a number of publishers in the platform community. The accounting data 310 may also include a number of credits or amount of money deducted from a particular publisher's account for display of the particular publisher's content. The accounting data 310 may further contain data related to credits purchased by a publisher and money “cashed out” of the platform and provided to the publisher for use of that publisher's available inventory.

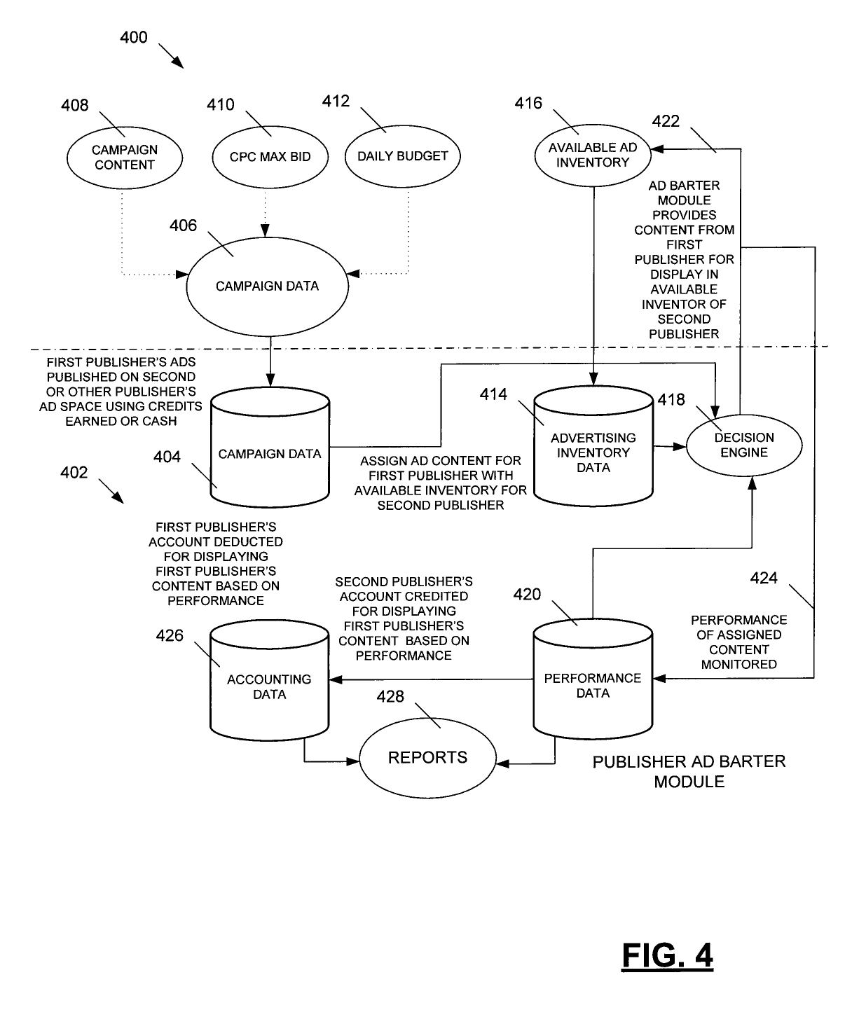

FIG. 4 is a block diagram depicting assignment of content to available advertisement inventory. A publisher ad barter module 402 includes a campaign data store 404 (e.g., a table in a data base, a database). Campaign data 406 is received from one or more publishers. Received campaign data 406 may include campaign content 408 in the form of graphics, audio, or text of an advertisement. The campaign data 406 may include other parameters of an advertising campaign or advertisement content including a cost per click maximum bid 410 and a daily budget 412.

The publisher ad barter module 402 may also include advertisement inventory data 414. One or more publishers may provide an identification of available inventory 416 that the publishers wish to sell. The advertisement inventory data 414 may include a location (e.g., web page, e-mail), where an advertisement should be provided. The advertisement inventory data 414 may also include restrictions on the sale of available inventory, such as particular publishers or particular advertisement content (e.g., content rated PG-13 or greater) that should not be provided for the available inventory 416.

A decision engine 418 receives campaign data 404 and advertising inventory data 414 to perform an assignment of particular content to a particular inventory. The decision engine may consider stored past performance data 420 to aid in the assignment decision. For example, the decision engine 418 may seek to assign content having a largest likelihood of click through achievement to a particular available inventory. Thus, the decision engine 418 may consider past performance data 420 to aid in that prediction process. At 422, the publisher ad barter module 402 assigns particular content to a particular available inventory 416 and provides the assigned content to the available inventory 416 for display.

Performance of the particular content in the particular available inventory 416 is monitored and stored as performance data, as indicated at 424. For example, the publisher ad barter module 402 may determine whether a click through is achieved for a particular impression. The details of the impression as well as the impression's success are stored as performance data 420. The newly stored performance data may be used in making future assignment decisions by the decision engine 418. The newly stored performance data may also be provided to an accounting data store 426 (e.g., table, database). Based on the newly stored performance data, the first publisher's account may be deducted from for display of the first publisher's content. Additionally, the second publisher's account may be added to for displaying the first publisher's content.

The performance data 420 and the accounting data 426 may be used to generate one or more reports 428. The reports 428 may cover a variety of metrics including performance of a particular content, performance of a particular advertisement campaign, performance of a particular inventory space, as well as other metrics.

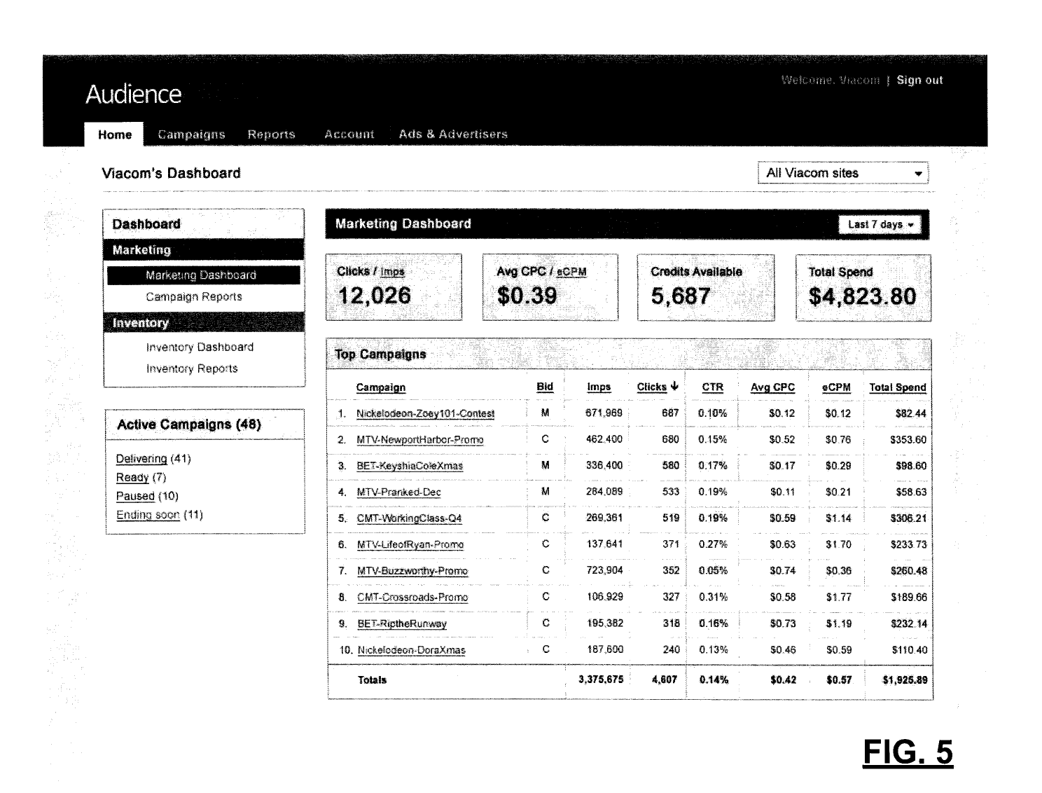

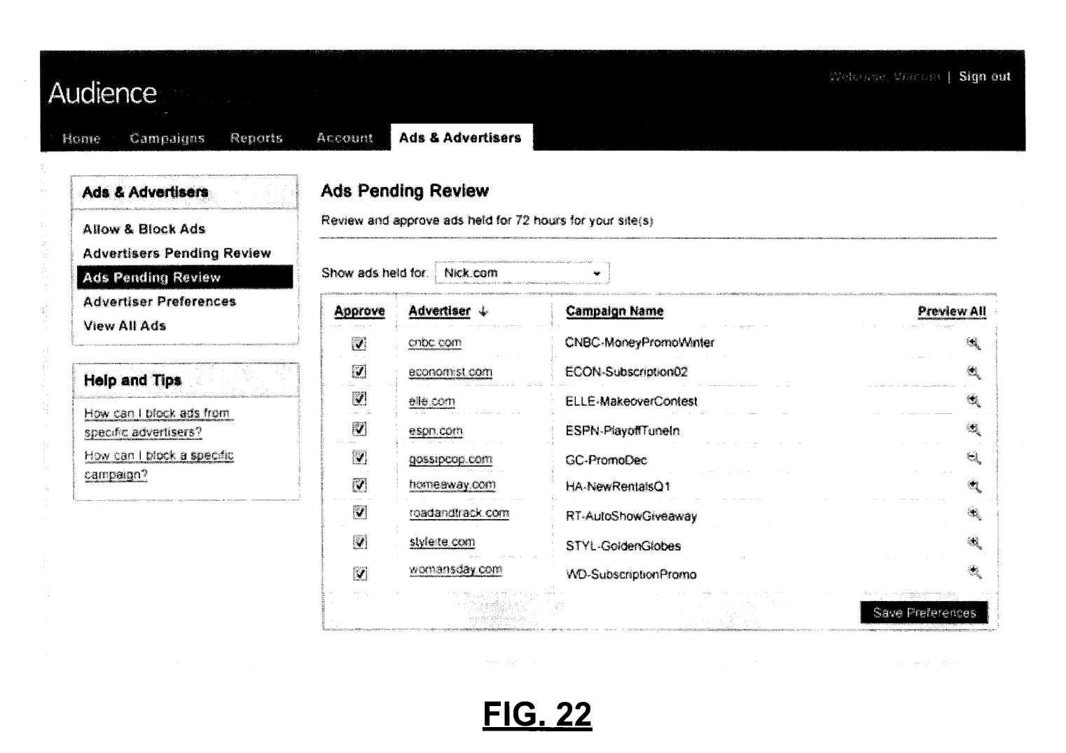

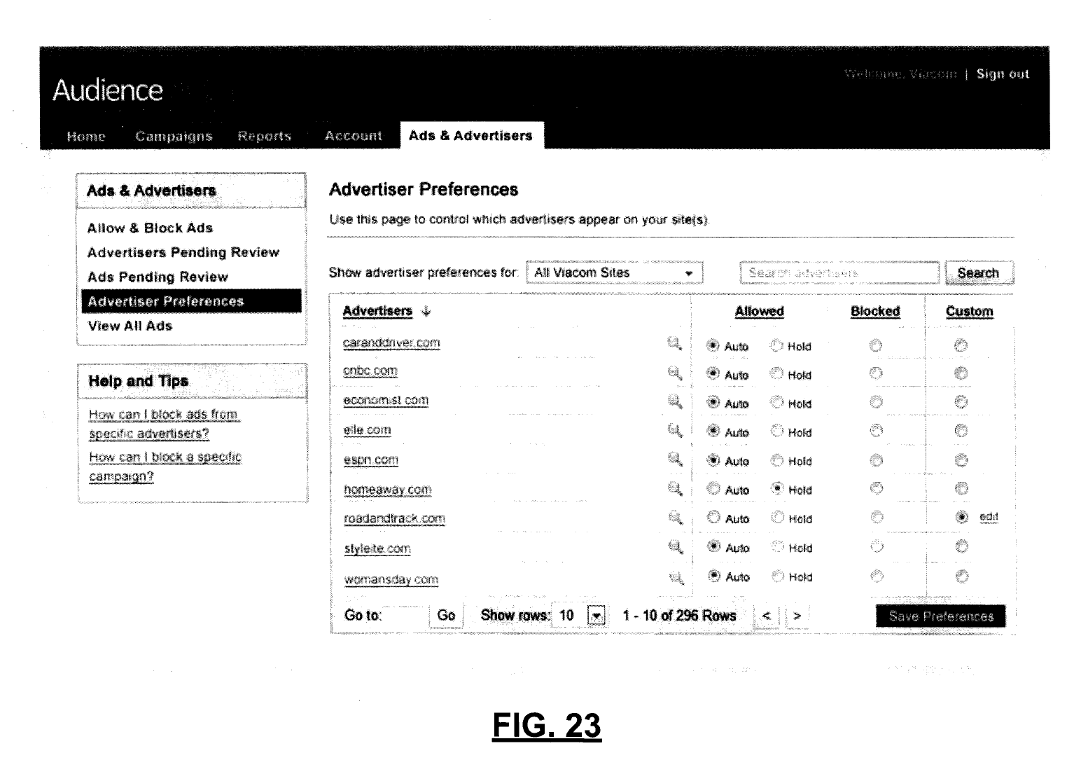

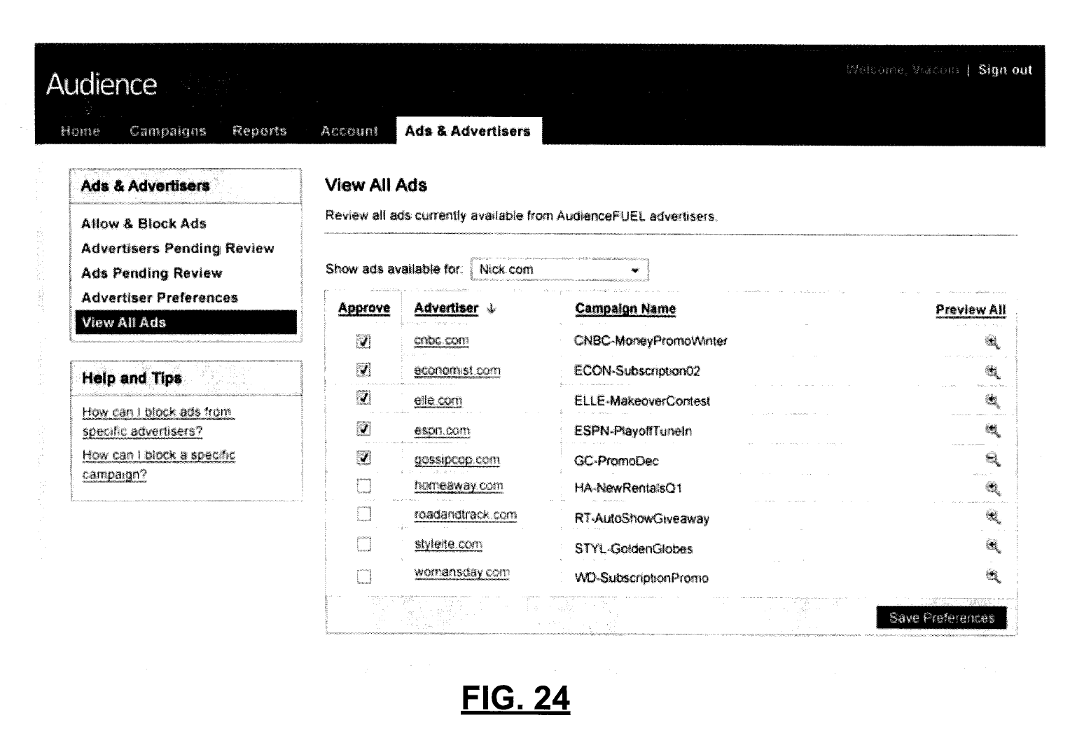

FIGS. 5-24 depict examples of graphical user interfaces for administration of and monitoring of performance of advertisement campaigns and available advertisement inventory.

More specifically, FIG. 5 is a graphical user interface identifying metrics for a number of advertising campaigns for a particular publisher on a click through basis.

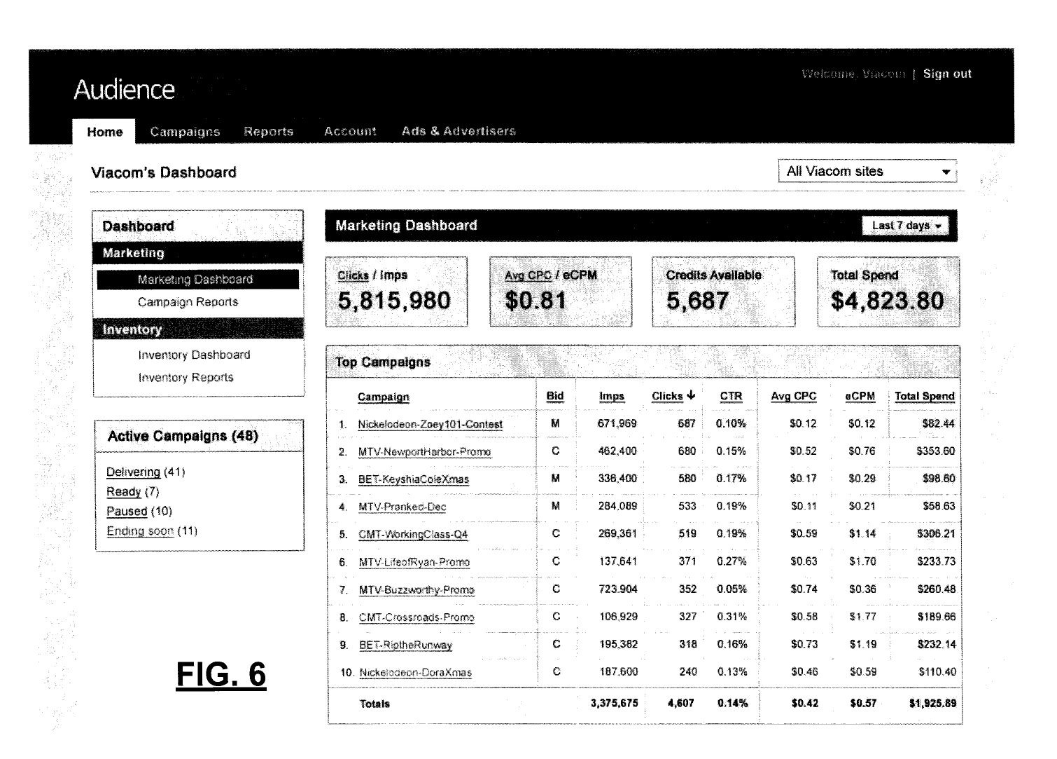

FIG. 6 is a graphical user interface identifying metrics for a number of advertising campaigns for a particular publisher on a number of impressions basis.

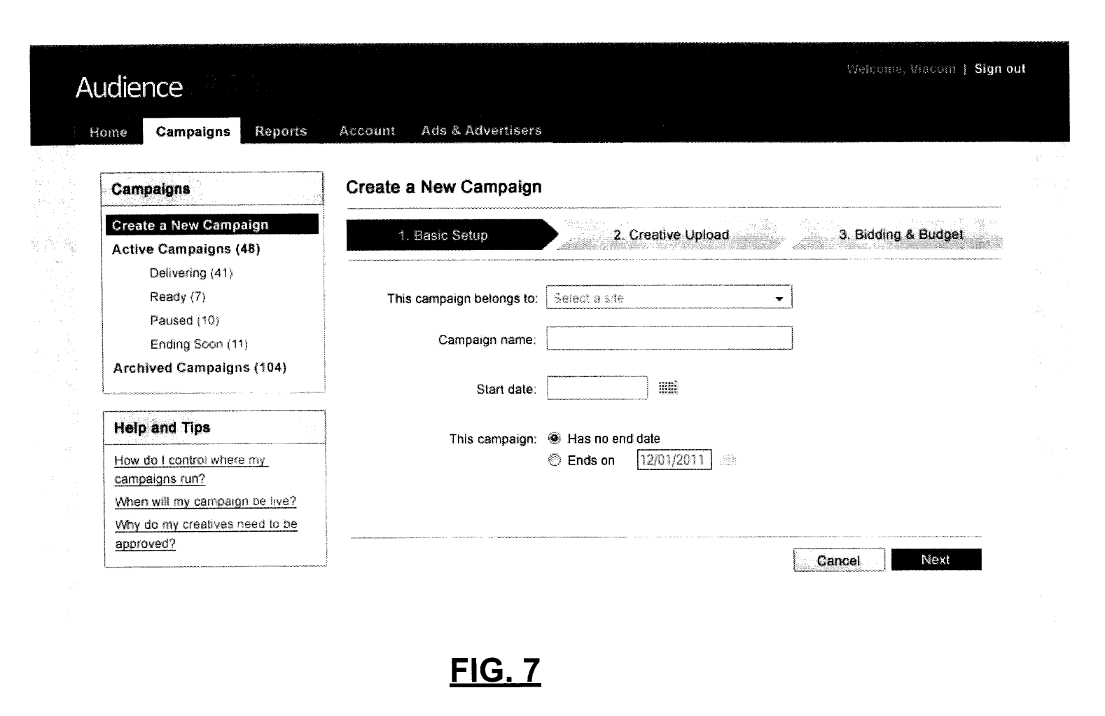

FIG. 7 is a graphical user interface for defining a new campaign for a particular publisher.

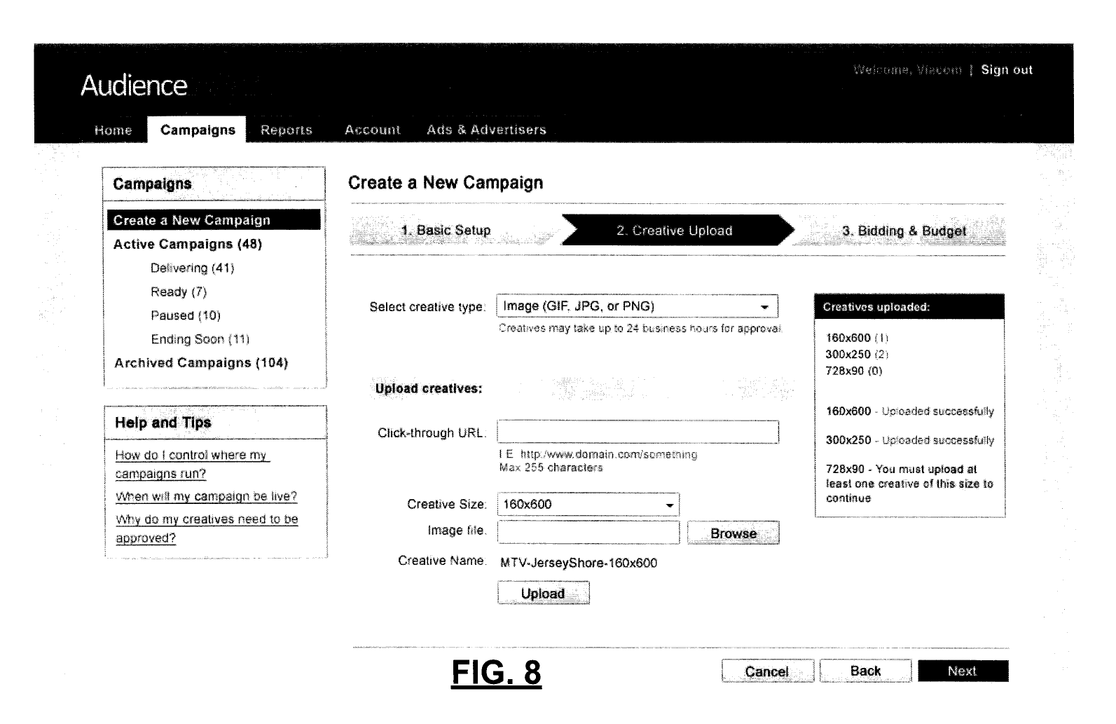

FIG. 8 is a graphical user interface for uploading campaign content for a particular campaign for a particular publisher.

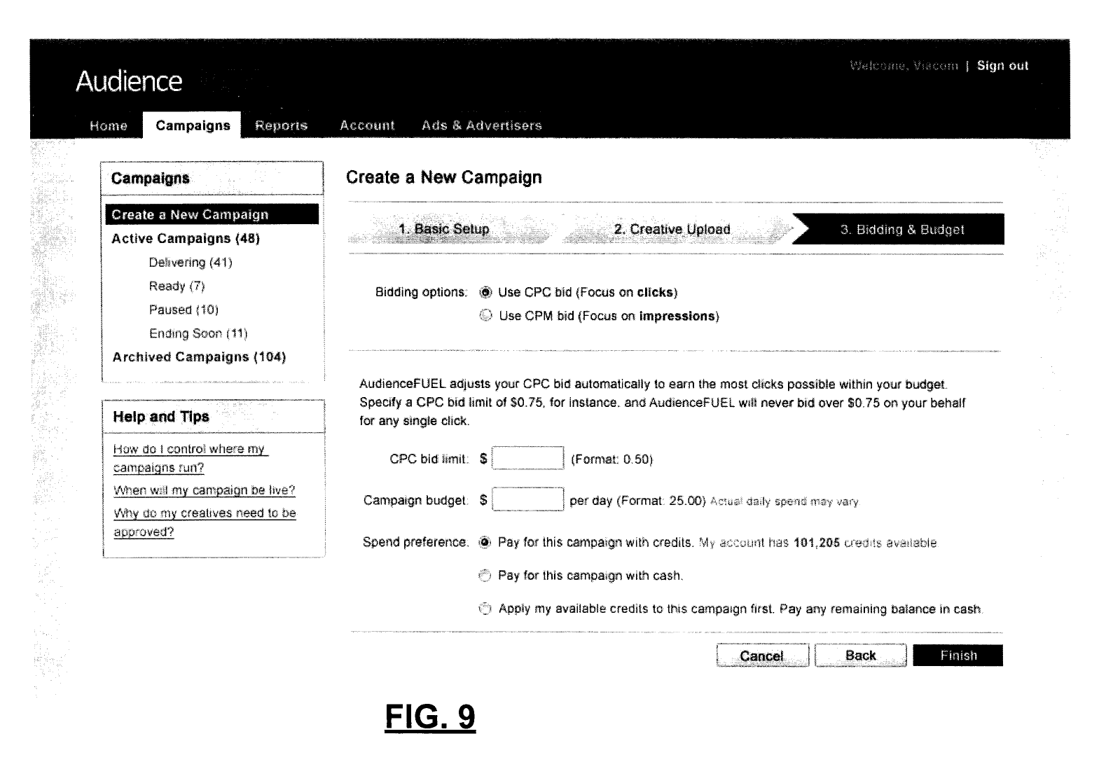

FIG. 9 is a graphical user interface for setting bid parameters and payment parameters for a new campaign for a particular publisher.

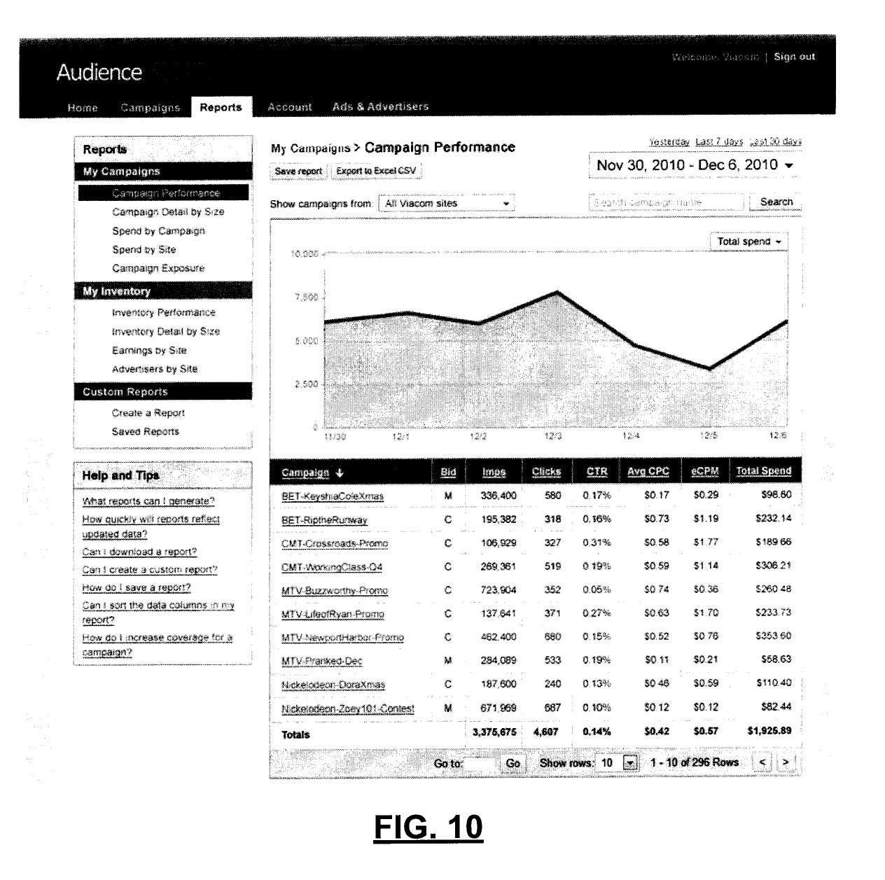

FIG. 10 is a graphical user interface depicting performance of a plurality of campaigns for a particular publisher over time.

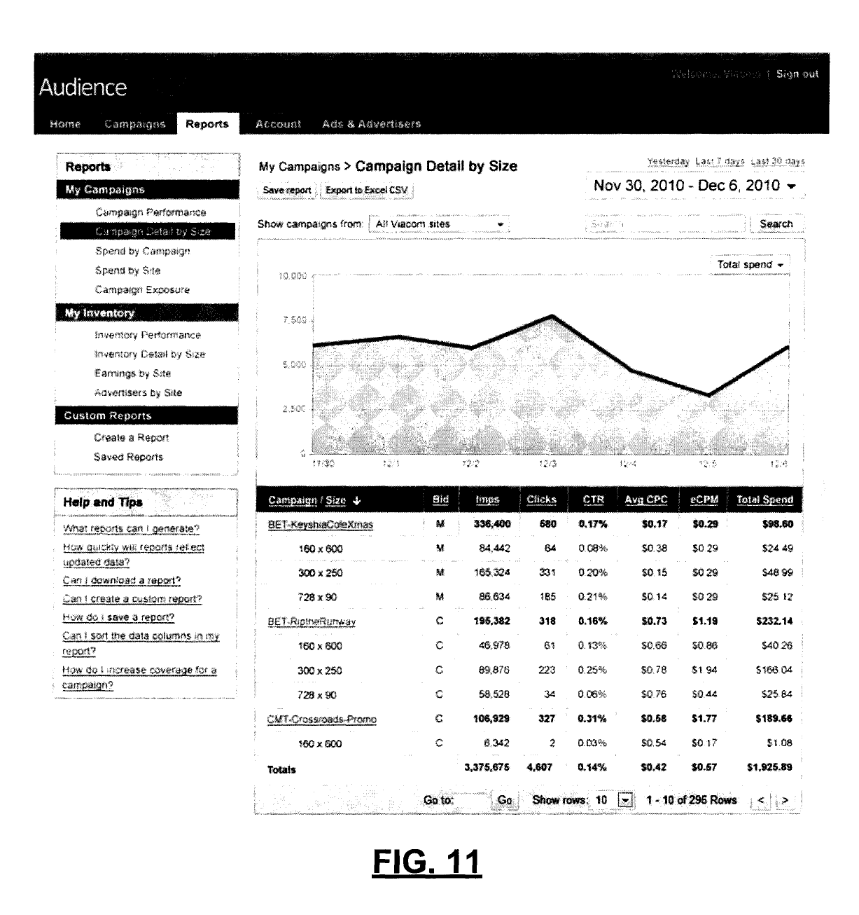

FIG. 11 is a graphical user interface depicting performance of a plurality of campaigns for a particular publisher over time according to content size.

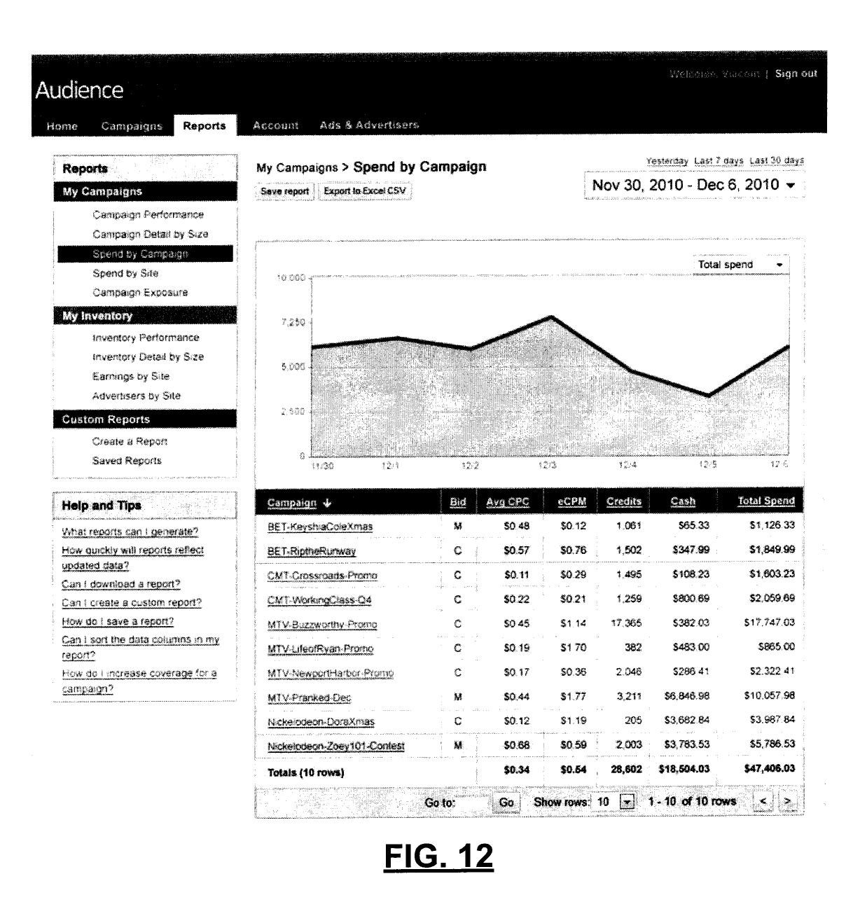

FIG. 12 is a graphical user interface depicting total spends for advertising campaigns of a particular publisher.

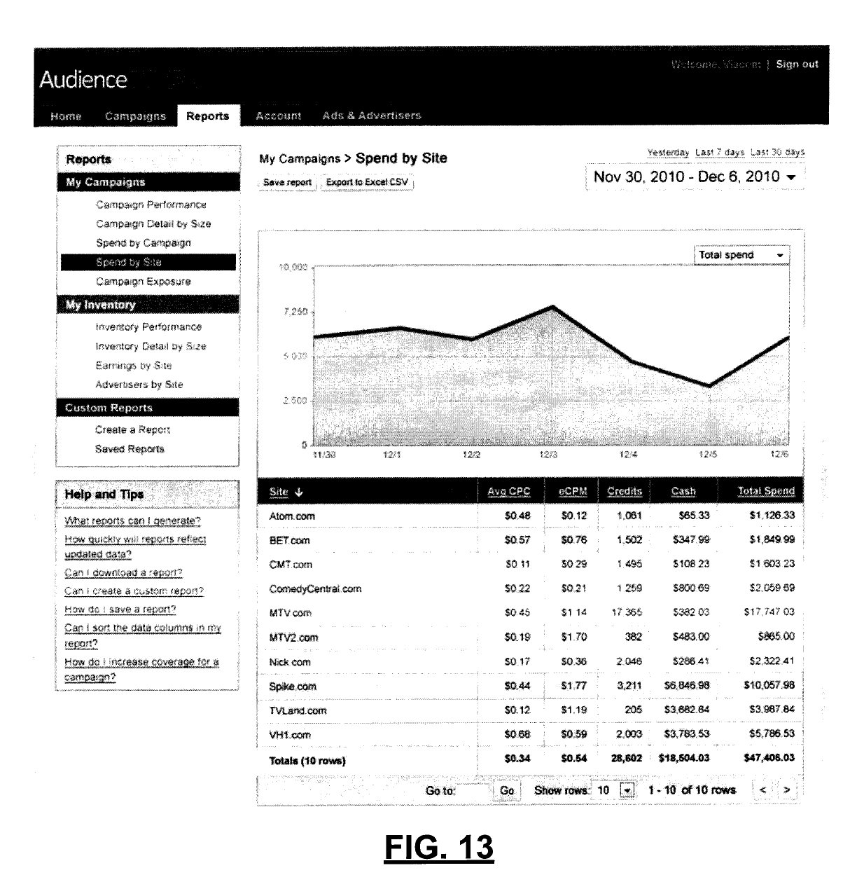

FIG. 13 is a graphical user interface depicting total spends for different sites containing available inventory.

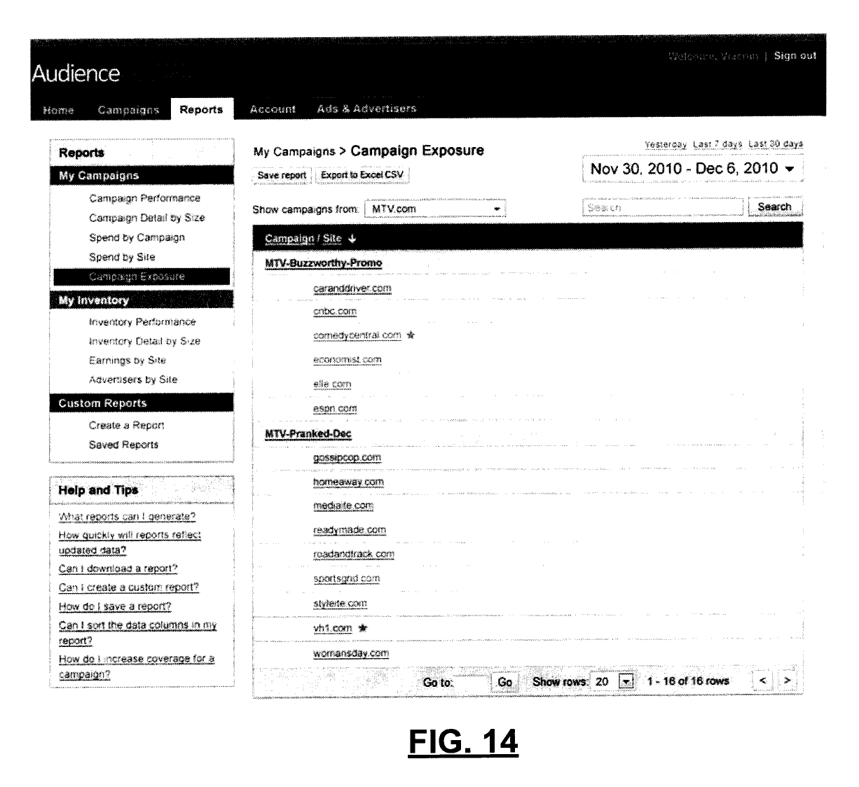

FIG. 14 is a graphical user interface identifying other publishers' websites where a publisher's content has been displayed.

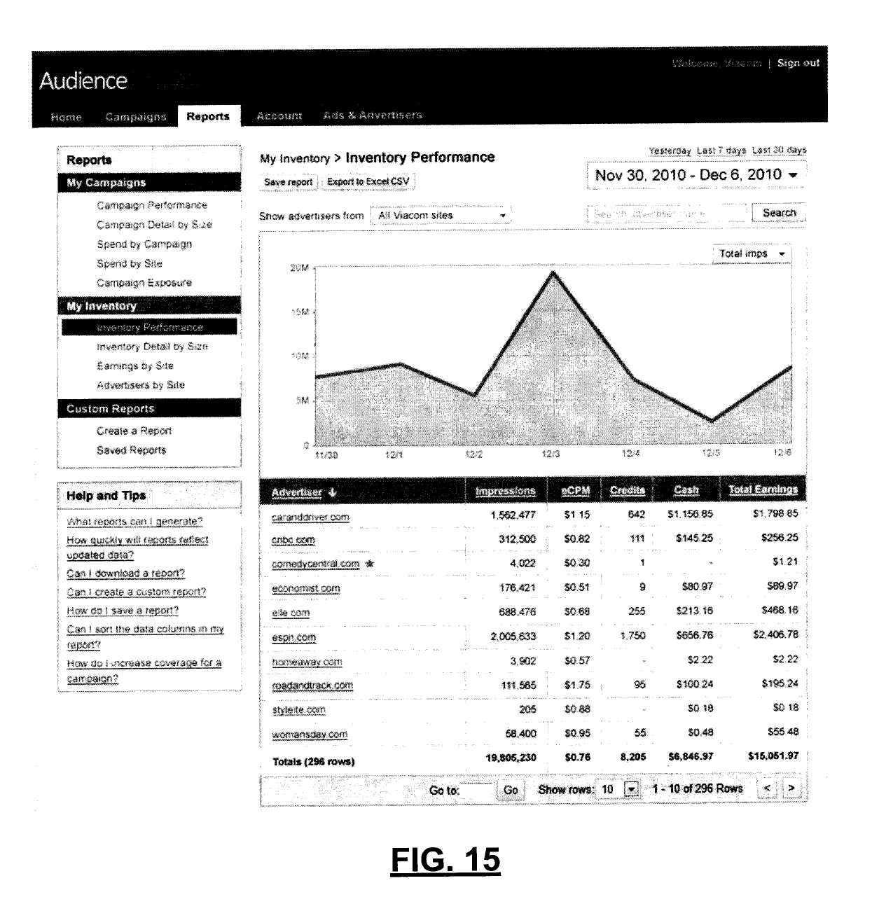

FIG. 15 is a graphical user interface depicting performance of a publisher's available inventory.

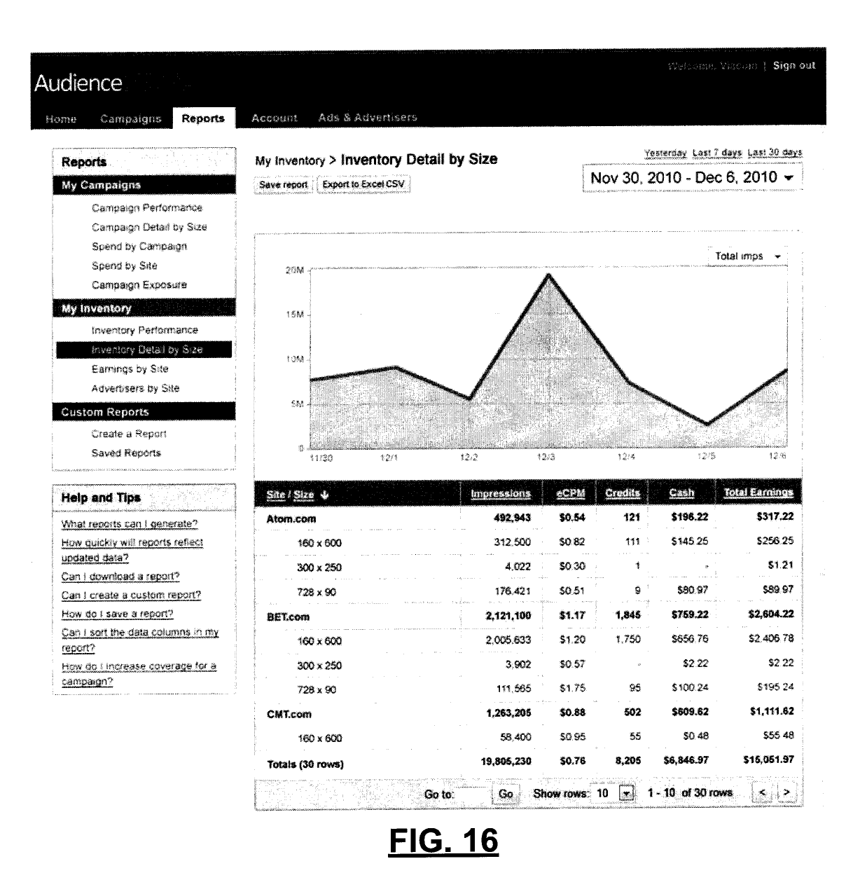

FIG. 16 is a graphical user interface depicting performance of a publisher's available inventory according to content size.

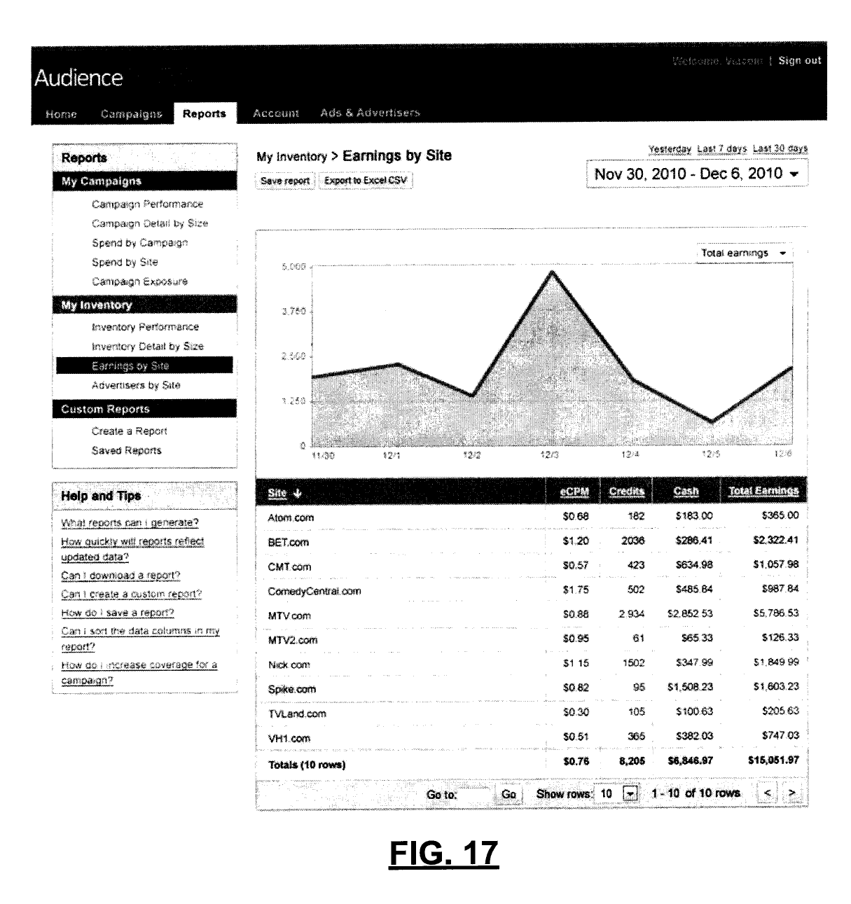

FIG. 17 is a graphical user interface depicting earnings for available inventory according to other publishers who provide content for display on the available inventory.

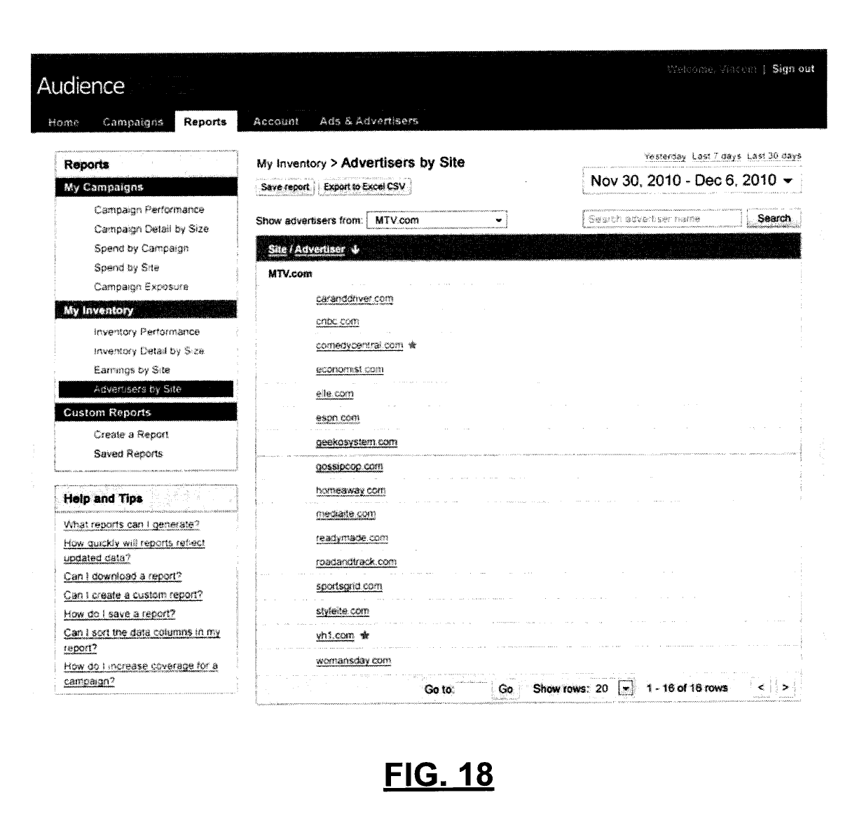

FIG. 18 is a graphical user interface depicting other publishers who provide content for display on available inventory.

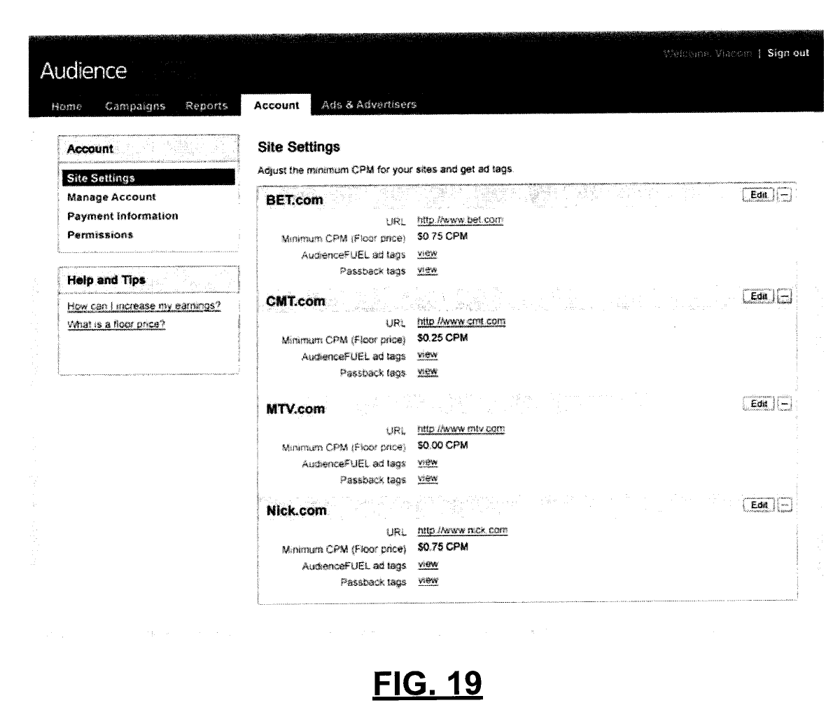

FIG. 19 is a graphical user interface depicting parameters for different advertising campaigns for a particular publisher.

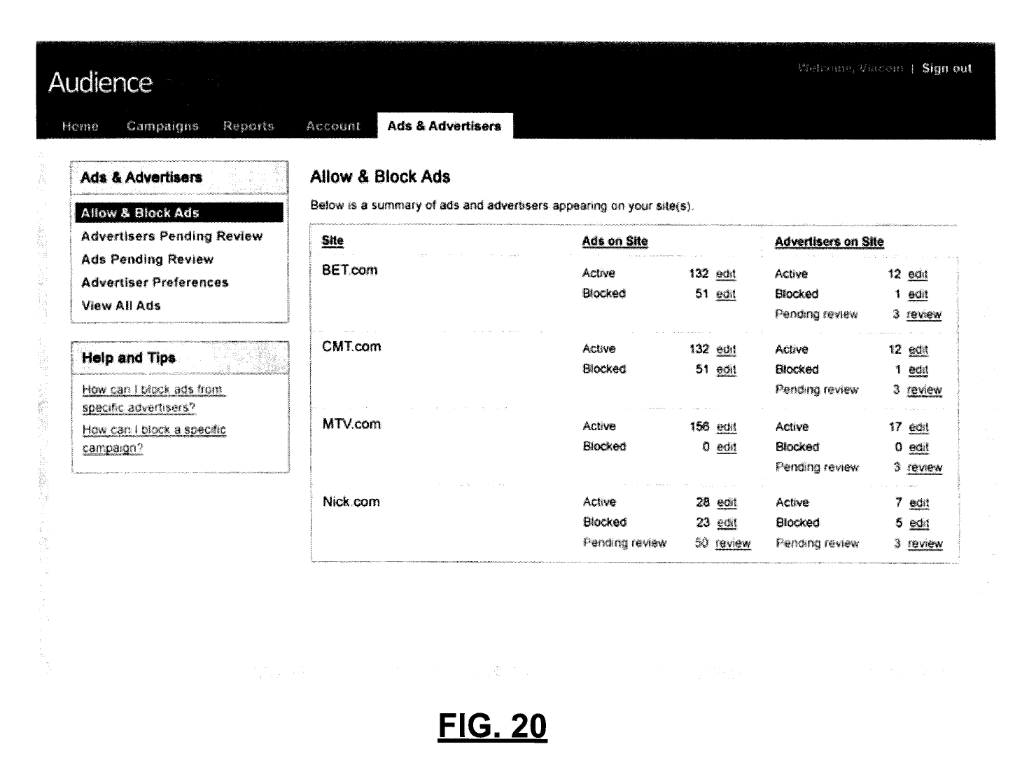

FIG. 20 is a graphical user interface depicting a number of blocked advertisements for different available inventory.

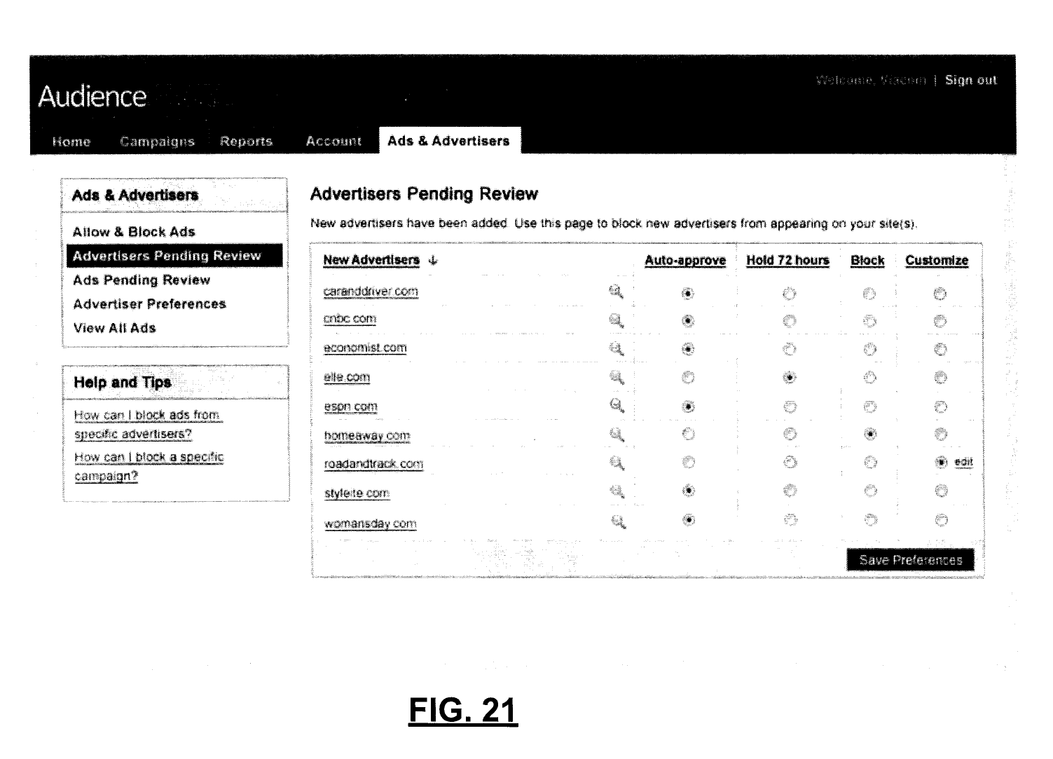

FIGS. 21-24 are graphical user interfaces for reviewing, blocking, and allowing particular publishers from displaying on available inventory.

FIG. 25 is a flow diagram depicting a computer-implemented method for publishers to barter advertisement inventory and advertisement content with other publishers by transmitting content from a first publisher for display on available inventory of a second publisher, where the content is transmitted to the second publisher in exchange for credit that may be previously earned by the first publisher for displaying other content for other publishers. Content is received from a first publisher at 2502. At 2504, an identification of an available advertisement inventory is received from a second publisher. The content is matched at 2506 with the available inventory, and the content is transmitted to the second publisher for display. Performance of the content displayed by the second publisher is monitored at 2508. At 2510, a credit amount is deducted for the first publisher based on the monitored performance of the content displayed by the second publisher, and at 2512, a credit amount (e.g., the same credit amount or a different credit amount) is added for the second publisher based on the monitored performance of the content displayed by the second publisher.

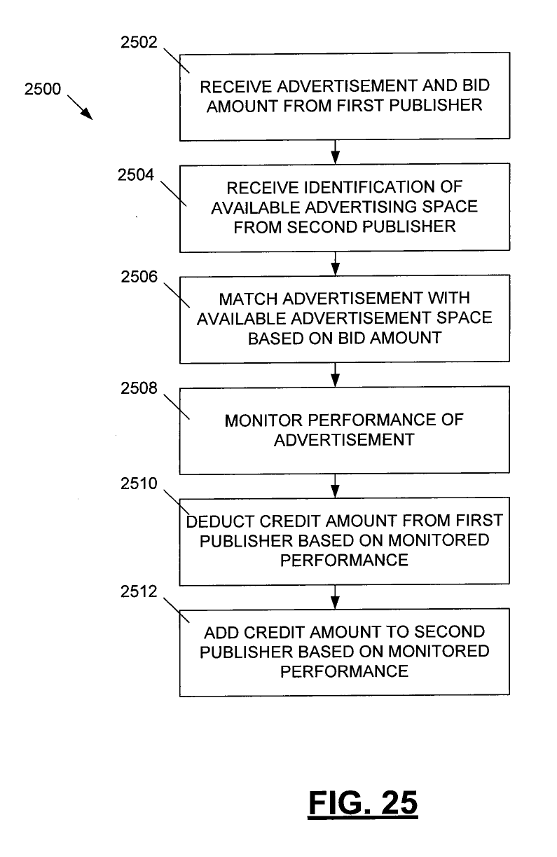

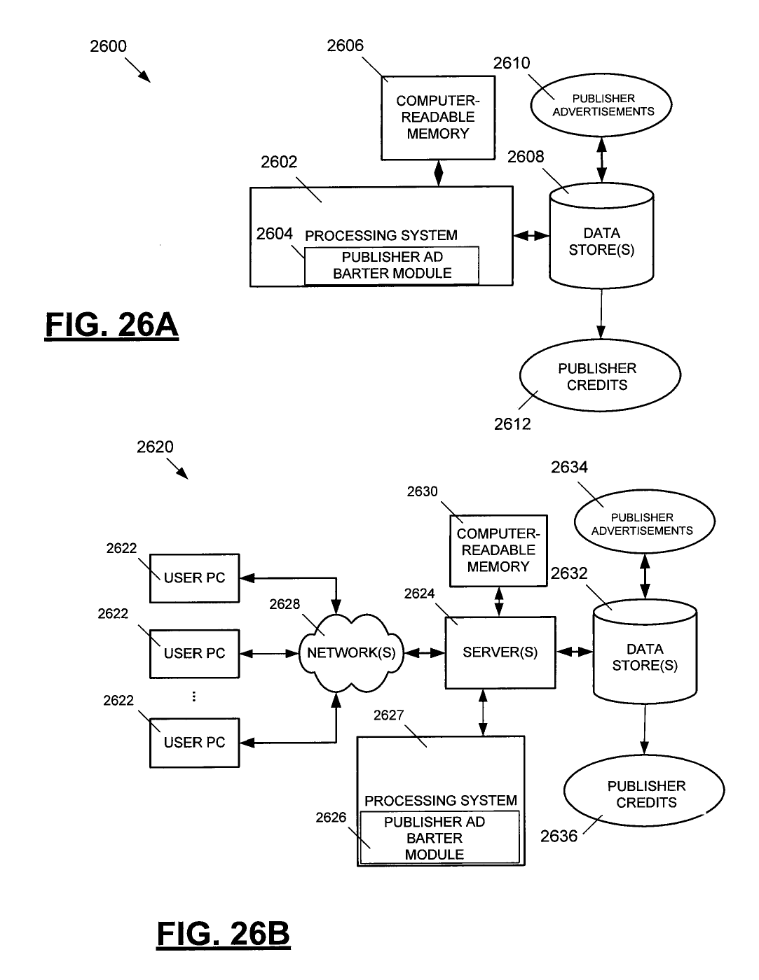

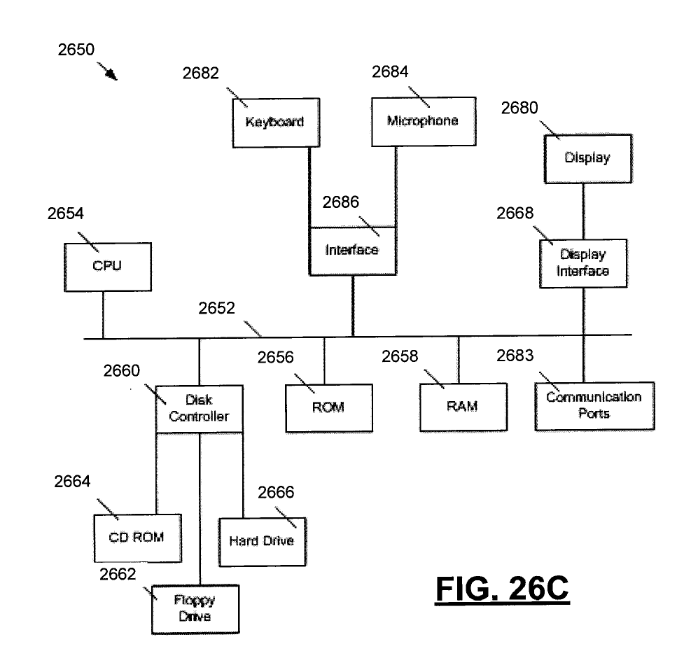

FIGS. 26A, 26B, and 26C depict example systems for use in implementing a publisher ad barter module. For example, FIG. 26A depicts an exemplary system 2600 that includes a standalone computer architecture where a processing system 2602 (e.g., one or more computer processors) includes a publisher ad exchange module 2604 being executed on it. The processing system 2602 has access to a computer-readable memory 2606 in addition to one or more data stores 2608. The one or more data stores 2608 may include publisher advertisement content 2610 as well as publisher credits 2612.

FIG. 26B depicts a system 2620 that includes a client server architecture. One or more user PCs 2622 access one or more servers 2624 running a publisher ad exchange module 2626 on a processing system 2627 via one or more networks 2628. The one or more servers 2624 may access a computer readable memory 2630 as well as one or more data stores 2632. The one or more data stores 2632 may contain publisher advertisement content 2634 as well as publisher credits 2636.

FIG. 26C shows a block diagram of exemplary hardware for a standalone computer architecture 2650, such as the architecture depicted in FIG. 26A that may be used to contain and/or implement the program instructions of system embodiments of the present invention. A bus 2652 may serve as the information highway interconnecting the other illustrated components of the hardware. A processing system 2654 labeled CPU (central processing unit) (e.g., one or more computer processors), may perform calculations and logic operations required to execute a program. A processor-readable storage medium, such as read only memory (ROM) 2656 and random access memory (RAM) 2658, may be in communication with the processing system 2654 and may contain one or more programming instructions for performing the method of implementing a publisher ad exchange module. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 2660 interfaces one or more optional disk drives to the system bus 2652. These disk drives may be external or internal floppy disk drives such as 2662, external or internal CD-ROM, CD-R, CD-RW or DVD drives such as 2664, or external or internal hard drives 2666. As indicated previously, these various disk drives and disk controllers are optional devices.

A display interface 2668 may permit information from the bus 2656 to be displayed on a display 2680 in audio, graphic, or alphanumeric format. Communication with external devices may optionally occur using various communication ports 2683.

In addition to the standard computer-type components, the hardware may also include data input devices, such as a keyboard 2682, or other input device 2684, such as a microphone, remote control, pointer, mouse and/or joystick.

As additional examples, for example, the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

1. A computer-implemented system for publishers to barter advertisement space inventory and advertisements with other publishers by transmitting an advertisement from a first publisher for display on available advertisement space inventory of a second publisher, where the advertisement is transmitted to the second publisher in exchange for credit previously earned by the first publisher for displaying other advertisements for other publishers, comprising:
a server including one or more data processors and one or more computer-readable mediums encoded with instructions for commanding the one or more data processors to execute a publisher advertisement barter module application;
one or more computer-readable mediums responsive to the publisher advertisement barter module, wherein the one or more computer-readable mediums contain:
a campaign data store that includes content data associated with advertisements of a plurality of publishers;
an accounting data store that includes credit amounts associated with the plurality of publishers;
wherein the publisher advertisement barter module assigns the advertisement from the first publisher to available advertisement space inventory of the second publisher and transmits the advertisement to the second publisher for display;
wherein a credit amount for the first publisher is deducted in response to the display of the advertisement by the second publisher, wherein credits have previously been earned by the first publisher for displaying other advertisements for other publishers;
wherein a credit amount for the second publisher is added in response to the display of the advertisement by the first publisher.

2. The system of claim 1, wherein the campaign data store further includes bid amounts associated with the advertisements of the plurality of publishers;
wherein the publisher advertisement barter module selects the advertisement from the first publisher for assignment to the available inventory of the second publisher based on a bid amount associated with the advertisement from the first publisher.

3. The system of claim 2, wherein the publisher advertisement barter module selects the advertisement from the first publisher from the campaign data store using an auction based on the bid amount associated with the advertisement from the first publisher.

4. The system of claim 2, wherein the bid amounts are maximum bids for click throughs.

5. The system of claim 1, wherein credit amounts include credits for displaying advertisements from other publishers and credits for money paid.

6. The system of claim 1, wherein the one or more computer-readable mediums responsive to the publisher advertising barter module application further contains:
a performance data store that includes performance data associated with an advertisement and performance data associated with an available inventory.

7. The system of claim 6, wherein the performance data associated with an advertisement includes: impressions, click through rate, average cost per click, effective cost per thousand impressions, effective cost per acquisition (CPA), or total spend.

8. The system of claim 6, wherein the performance data associated with an available inventory includes impressions, effective cost per thousand impressions, effective cost per acquisition (CPA), credits earned, cash earned, and total earnings.

9. The system of claim 6, wherein the credit amount for the first publisher is deducted according to performance of the display of the advertisement by the second publisher; and
wherein the credit amount for the second publisher is added according to performance of the display of the advertisement by the second publisher.

10. The system of claim 1, wherein the campaign data store includes prohibited publishers and prohibited advertisements associated with available inventory, wherein the publisher advertisement barter module does not assign particular advertisements or advertisements from a prohibited publisher to an available inventory based on the prohibited publishers or prohibited advertisements.

11. The system of claim 1, wherein the publisher advertising exchange module assigns the advertisement from the first publisher to the available inventory of the second publisher based on prior performance of the advertisement from the first publisher on advertisement inventory of the second publisher, wherein the prior performance is measured using a click through rate.

12. A computer-implemented method for publishers to barter advertisement space inventory and advertisements with other publishers by transmitting an advertisement from a first publisher for display on available advertisement space inventory of a second publisher, where the advertisement is transmitted to the second publisher in exchange for credit previously earned by the first publisher for displaying other advertisements for other publishers, comprising:
receiving an advertisement from a first publisher;
receiving an identification of an available advertisement space inventory from a second publisher;
matching the advertisement with the available inventory;
monitoring performance of the advertisement displayed by the second publisher;
deducting a credit amount for the first publisher based on the monitored performance of the advertisement displayed by the second publisher, wherein credits have previously been earned by the first publisher for displaying other advertisements for other publishers; and
crediting a credit amount for the second publisher based on the monitored performance of the advertisement displayed by the second publisher;
wherein the method is performed using one or more data processors.

13. The method of claim 12, wherein performance of the advertisement is monitored using click throughs.

14. The method of claim 12, wherein bid amounts are received from a plurality of publishers;
wherein the advertisement from the first publisher is selected for assignment to the available inventory of the second publisher over advertisements of other publishers based on a bid amount from the first publisher.

15. The method of claim 12, wherein credit amounts include credits for displaying advertisements from other publishers and credits for money paid.

16. The method of claim 12, further comprising capturing performance data associated with an advertisement and performance data associated with an available inventory.

17. The method of claim 16, wherein the performance data associated with an advertisement includes: impressions, click through rate, average cost per click, effective cost per thousand impressions, effective cost per acquisition (CPA), and total spend.

18. The method of claim 16, wherein the performance data associated with an available inventory includes impressions, effective cost per thousand impressions, effective cost per acquisition (CPA), credits earned, cash earned, and total earnings.

19. The method of claim 12, further comprising receiving an identification of prohibited publishers and prohibited advertisements associated with available inventory, wherein particular advertisements or advertisements from a prohibited publisher are not published to an available inventory based on the prohibited publishers and prohibited advertisements.

20. One or more computer-readable storage mediums encoded with instructions for commanding one or more data processors to perform a method for publishers to barter advertisement space inventory and advertisements with other publishers by transmitting an advertisement from a first publisher for display on available advertisement space inventory of a second publisher, where the advertisement is transmitted to the second publisher in exchange for credit previously earned by the first publisher for displaying other advertisements for other publishers, the method comprising:
receiving an advertisement from a first publisher;
receiving an identification of an available advertisement space inventory from a second publisher;
matching the advertisement with the available inventory;
monitoring performance of the advertisement displayed by the second publisher;
deducting a credit amount for the first publisher based on the monitored performance of the advertisement displayed by the second publisher; wherein credits have previously been earned by the first publisher for displaying other advertisements for other publishers; and
crediting a credit amount for the second publisher based on the monitored performance of the advertisement displayed by the second publisher.
